(19) United States
(12) Patent Application Publication
(10) Pub. No.: US 2011/0043001 A1
(43) Pub. Date: Feb. 24, 2011

(54) Rear wheel housing reinforcement unit for vehicle

(75) Inventor: Ki Chang Kim, Suwon-city (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/623,158

(22) Filed: Nov. 20, 2009

(30) Foreign Application Priority Data
Aug. 21, 2009 (KR) 10-2009-0077854

(51) Int. Cl. B62D 25/08

(52) U.S. Cl. 296/198

(57) ABSTRACT

A rear wheel housing reinforcement unit for a vehicle is provided in which connecting each rear wheel housings including an inner panel and an outer panel and reinforcing the rear wheel housings. The rear wheel housing reinforcement unit includes a quarter main panel configured to an upper portion of the each rear wheel housing, a roof rear rail connecting an upper portion of the each quarter main panel and a quarter reinforcement which is configured to an outer side of the quarter main panel and of which an upper end is connected to an end of the roof rear rail.

### CROSS-REFERENCE TO RELATED APPLICATION

The present application claims priority of Korean Patent Application Number 10-2009-0077854 filed Aug. 21, 2009, the entire contents of which application is incorporated herein for all purposes by this reference.

### BACKGROUND OF THE INVENTION

1. Field of the Invention

The present invention relates to a rear wheel housing reinforcement unit for a vehicle. More particularly, the present invention relates to a rear wheel housing reinforcement unit that may disperse load delivered from a suspension so as to minimize load delivered to a rear wheel housing.

2. Description of Related Art

Generally, a rigidity of a mounting portion of a vehicle suspension is a key factor to determine characteristics of NVH (Noise Vibration Harshness), and deriving and handling performance of a vehicle

Generally suspensions are mounted between forward and rearward wheels and a vehicle body, and one end of the suspension is connected to a knuckle connected to wheels and the other end of the suspension is connected to a wheel housing.

The wheel housing includes a front wheel housing and a rear wheel housing, and the rear wheel housing 100, as shown in FIG. 3, includes an inner panel 101 and an outer panel 103 and the inner panel 101 and the outer panel 103 are connected.

The rear wheel housings 100 are generally formed as a pair, and quarter main panels 105 are configured to an upper portion thereof respectively.

The rear wheel housing 100 and the quarter main panel 105 are connected by a rear wheel housing reinforcement unit 110.

The conventional rear wheel housing reinforcement unit 110, as shown in FIG. 4, includes a plurality of reinforcements 111, a roof rear rail 113 and quarter reinforcement panel 119.

The plurality of reinforcements 111 are connected each other and configured to a side of the quarter main panel 105.

The roof rear rail 113 includes an upper rail 115 and an outer rail 117 and the upper rail 115 and the outer rail 117 are connected through the reinforcements 111 configured to the quarter main panel 105.

The quarter reinforcement panel 119 is configured to a lower portion of the quarter main panel 105 and the rear wheel housing 100.

However, the conventional rear wheel housing reinforcement unit 110 is dispersedly disposed to the rear wheel housing 100 and the quarter main panel 105 so that connections of each elements are fragile and thus it is difficult to disperse loads delivered from a suspension to the rear wheel housing in driving, especially in impact and vibration.

The conventional rear wheel housing reinforcement unit 110 may not effectively reduce impact and vibration and NVH performance and value of a vehicle are deteriorated.

Also, pluralities of reinforcement 111 are required, so that manufacturing process and cost are increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention provide for a rear wheel housing reinforcement unit for a vehicle having advantages of dispersing load delivered from a suspension to a rear wheel housing with simple scheme.

A rear wheel housing reinforcement unit for a vehicle according to various embodiments of the present invention, which connecting each rear wheel housings including an inner panel and an outer panel and reinforcing the rear wheel housings, the rear wheel housing reinforcement unit may include a quarter main panel configured to an upper portion of the each rear wheel housing, a roof rear rail connecting an upper portion of the each quarter main panel and a quarter reinforcement which is configured to an outer side of the quarter main panel and of which an upper end is connected to an end of the roof rear rail.

A lower portion of the quarter main panel may be formed the same as shaped as an the rear wheel housing and the quarter main panel is formed integrally.

The roof rear rail may include stepped portions that are formed as stepped and a supporting portion that is disposed between the stepped portions and convexly protrudes along length direction of the roof rear rail.

The supporting portion may be shaped as “U”.

A lower portion of the quarter reinforcement may be connected to an exterior circumference of the outer panel.

An internal circumference of the quarter reinforcement may be connected to an exterior circumference of the quarter main panel

The roof rear rail and the quarter reinforcement may be connected and form shaped as “U”.

A rear wheel housing reinforcement unit for a vehicle according to various embodiments of the present invention includes a roof rear rail and a quarter reinforcement connected to each other for dispersing load delivered from a suspension to a rear wheel housing so that generating vibration in the rear wheel housing can be minimized and noise induced by the vibration can be reduced.

Also, the rear wheel housing reinforcement unit for a vehicle according to various embodiments of the present invention can reduce a plurality of reinforcement, manufacturing processes, manufacturing cost and so on, and a quarter main panel can be integrally formed.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary rear wheel housing reinforcement unit according to the present invention.

FIG. 2 is an exploded perspective view of the rear wheel housing reinforcement unit of FIG. 1.

FIG. 3 is a perspective view of a rear wheel housing reinforcement unit according to a conventional art.

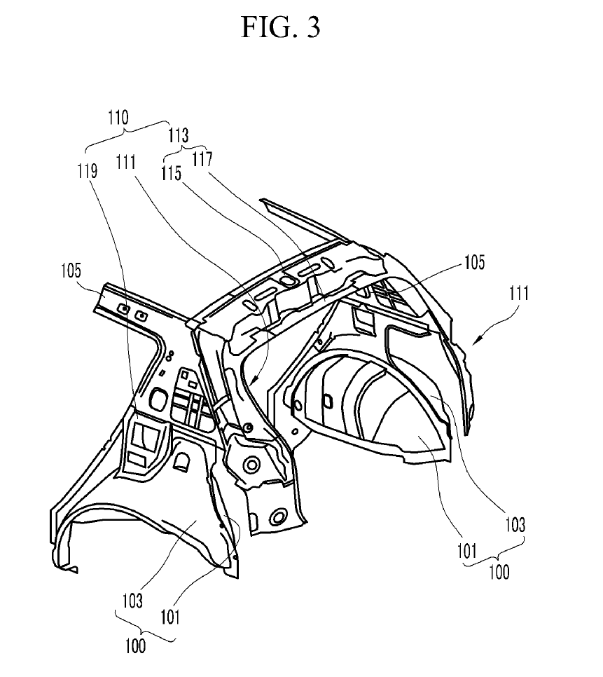

FIG. 4 is an exploded perspective view of a rear wheel housing reinforcement unit according to a conventional art.

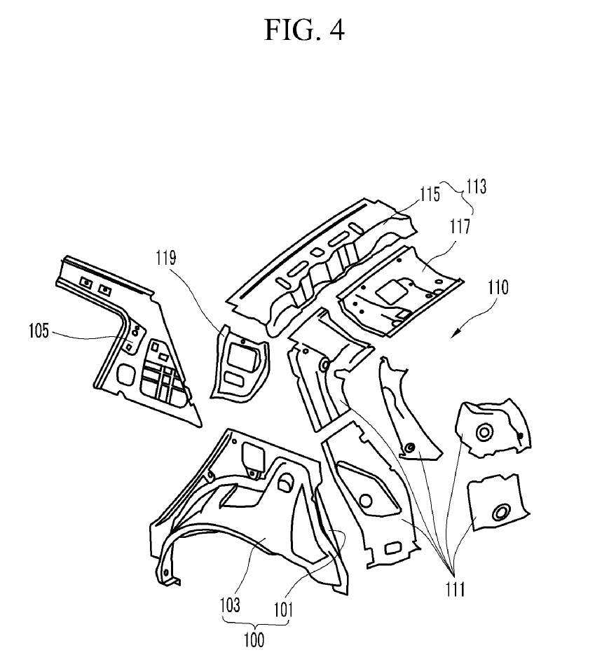

FIG. 5 is a graph showing frequency-dB characteristics of an exemplary rear wheel housing reinforcement unit according to the present invention and according to a conventional art.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

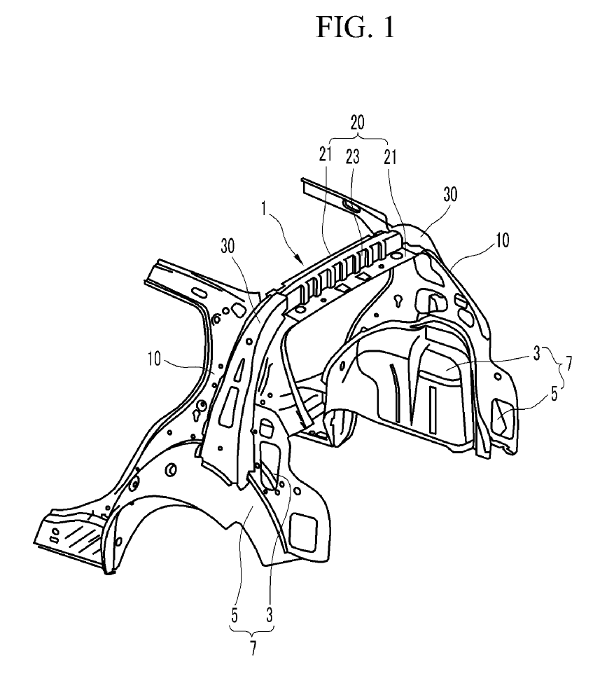

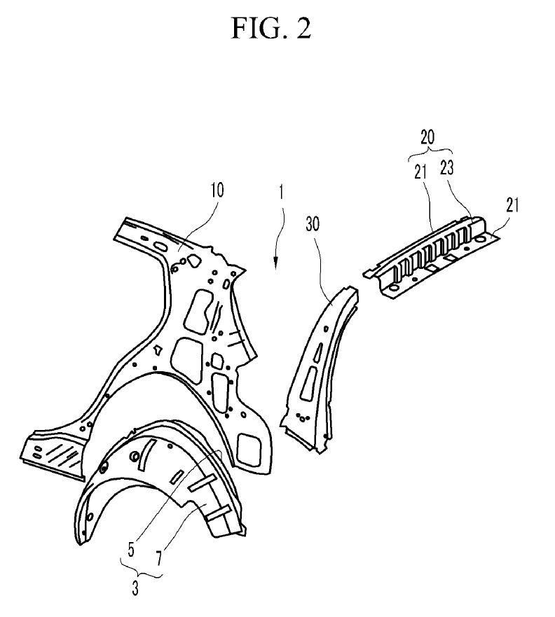

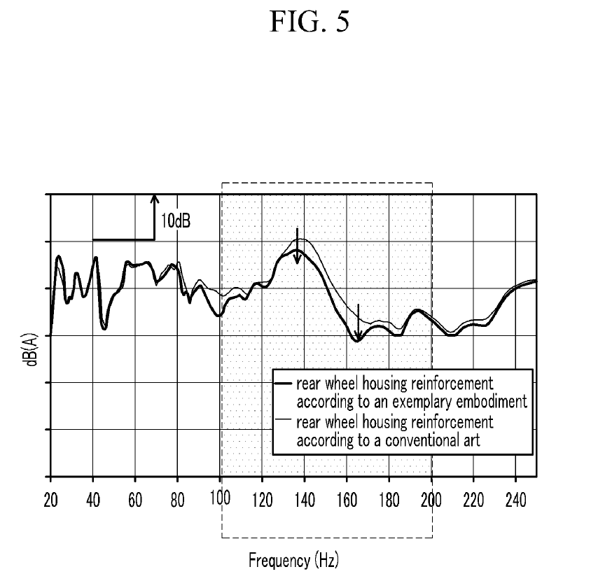

FIG. 1 and FIG. 2 are a perspective view and an exploded perspective view of a rear wheel housing reinforcement unit according to various embodiments of the present invention, and FIG. 5 is a graph showing frequency-dB characteristics of a rear wheel housing reinforcement unit according various embodiments of the present invention and according to a conventional art.

Referring the drawing, a rear wheel housing reinforcement unit 1 according to various embodiments of the present invention includes a roof rear rail 20 and a quarter reinforcement 30 connected to each other for dispersing load delivered from a suspension (not shown) to a rear wheel housing 7 so that generating vibration in the rear wheel housing 7 can be minimized and noise induced by the vibration can be reduced.

The rear wheel housing 7 for supporting the suspension includes an inner panel 3 and an outer panel 5.

The quarter main panel 10 is configured to an upper portion of the rear wheel housing 7.

A lower portion of the quarter main panel 10 is formed as an exterior surface of the rear wheel housing 7 and integrally formed as one body. In other words, a lower portion of the quarter main panel 10 and an exterior surface of the rear wheel housing may be monolithically formed.

Thus, the quarter main panel 10 is formed one panel so that elements for reinforcing can be reduced and manufacturing processes and cost can be reduced.

The each rear wheel housing 7 is connected by connection of the roof rear rail 20 with an upper portion of the each quarter main panel 10.

The roof rear rail 20 includes stepped portions 21 that are formed as stepped and a supporting portion 23 that is disposed between the stepped portions 21 and convexly protrudes along length direction of the roof rear rail 20.

The supporting portion 23 is shaped as “U”.

The quarter reinforcement 30 is configured to an exterior circumference of the quarter main panel 10 and an upper portion of the quarter reinforcement 30 is connected to ends of the roof rear rail 20 and a lower portion of the quarter reinforcement 30 is connected to an exterior circumference of the outer panel 5.

An interior circumference of the quarter reinforcement 30 fits an exterior circumference of the quarter main panel 10.

The interior circumference of the quarter reinforcement 30 may be shaped as the exterior circumference of the quarter main panel 10.

That is the interior circumference of the quarter reinforcement 30 fits and reinforces the quarter main panel 10.

Thus, the quarter reinforcement 30 connects the ends of the roof rear rail 20 wrapping the quarter main panel 10 with the roof rear rail 20 and supports the rear wheel housing 7.

The rear wheel housing reinforcement unit 1 can effectively disperse load delivered from the rear wheel housing 7 with the “U” shaped supporting portion 23 and the quarter reinforcement 30.

Thus, the rear wheel housing 7 of the rear wheel housing reinforcement unit 1, as shown in FIG. 5, can reduce noise in the back seat about 2-5 dB in 100 Hz-200 Hz frequency comparing the conventional art.

That is, the rear wheel housing reinforcement unit 1 can reduce vibration in the rear wheel housing 7 and also noise induced by the vibration can be reduced.

In addition, the rear wheel housing reinforcement unit 1 can eliminate a plurality of reinforcement that are used in the conventional and form quarter main panel 10 as one panel so that total elements and manufacturing cost can be reduced.

Thus, the rear wheel housing reinforcement unit 1 according to various embodiments of the present invention may disperse load delivered from a suspension (not shown) to the rear wheel housing 7 using the roof rear rail 20 and the quarter reinforcement 30 for connecting the rear wheel housing 7 and reduce vibration and noise so that NVH performance and value of a vehicle can be enhanced.

Also, the roof rear rail 20 and the quarter reinforcement 30 are connected to form as U″ shape so that rigidity can be enhanced and vibration and noise can be effectively reduced.

For convenience in explanation and accurate definition in the appended claims, the terms “upper” or “lower”, “front” or “rear”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A rear wheel housing reinforcement unit for a vehicle, in which an inner panel and an outer panel connect and reinforce rear wheel housings, the rear wheel housing reinforcement unit comprising:
a quarter main panel connected to an upper portion of the each rear wheel housing;
a roof rear rail connecting an upper portion of the each quarter main panel; and
a quarter reinforcement connected to an outer side of the quarter main panel and having an upper end connected to an end of the roof rear rail.

2. The rear wheel housing reinforcement unit of claim 1, wherein a lower portion of the quarter main panel is formed with the same shape as an the rear wheel housing, and wherein the quarter main panel is monolithically formed.

3. The rear wheel housing reinforcement unit of claim 1, wherein the roof rear rail comprises:
stepped portions that are formed as stepped; and
a supporting portion that is disposed between the stepped portions and convexly protrudes along length direction of the roof rear rail.

4. The rear wheel housing reinforcement unit of claim 3, wherein the supporting portion is U-shaped.

5. The rear wheel housing reinforcement unit of claim 1, wherein a lower portion of the quarter reinforcement is connected to an exterior circumference of the outer panel.

6. The rear wheel housing reinforcement unit of claim 1, wherein an internal circumference of the quarter reinforcement is connected to an exterior circumference of the quarter main panel

7. The rear wheel housing reinforcement unit of claim 1, wherein the roof rear rail and the quarter reinforcement are connected and form shaped as “U”.

8. A vehicle body comprising the rear wheel housing reinforcement of claim 1.
